(19) United States
(12) Patent Application Publication
(10) Pub. No.: US 2015/0128844 A1
(43) Pub. Date: May 14, 2015

(54) TYPE-4 TANK FOR CNG CONTAINMENT

(71) Applicants: Francesco Nettis, London (GB); Vanni Neri Tomaselli, Luxembourg (LU)

(72) Inventors: Francesco Nettis, London (GB); Vanni Neri Tomaselli, Luxembourg (LU)

(73) Assignee: Blue Wave Co S.A., Luxembourg (LU)

(21) Appl. No.: 14/363,190

(22) PCT Filed: Dec. 5, 2011
(86) PCT No.: PCT/EP2011/071789

§ 371 Date: Nov. 21, 2014

(51) Int. Cl. F17C 1/00; B63B 25/14; B65D 90/10; F17C 1/10; B65D 25/14

(52) U.S. Cl. CPC F17C 1/002; F17C 1/10; B65D 25/14; B65D 90/10; B63B 25/14
USPC 114/74 R; 220/589; 220/590

(57) ABSTRACT

The present invention relates to a pressure vessel for containing or transporting pressurized gas. More particularly it relates to such vessels for containing or transporting compressed natural gas. The present invention also relates to a method of storing or transporting gas onshore or offshore. Moreover, the present invention relates to a vehicle for transporting gas, in particular compressed natural gas.

### FIELD OF THE INVENTION

The present invention relates to pressure vessels for containing or transporting pressurized gas in a ship. More particularly it relates to such vessels for containing or transporting compressed natural gas (CNG).

The present invention also relates to a method of storing or transporting gas onshore or offshore. Moreover, the present invention relates to a vehicle for transporting gas, in particular compressed natural gas.

### BACKGROUND ART

Increased capacity and efficiency requests in the field of CNG transportation, and the common use of steel-based cylinders therefor, has led to the development of steel-based cylinders with a thicker structure, which usually results in a heavy device or a device with a lower mass ratio of transported gas to containment system. This effect can be overcome with the use of advanced and lighter materials such as composite structures. After all, seafaring vessels have a load-bearing limit based upon the buoyancy of the vehicle, much of which load capacity is taken up by the physical weight of the vessels—i.e. their “empty” weight.

Some existing solutions therefore already use composite structures in order to reduce the weight of the device, but the size and configuration of the composite structures are not optimized, for example due to the limitations of the materials used. For example, the use of small cylinders or non-traditional shapes of vessel often leads to a lower efficiency in terms of transported gas (smaller vessels can lead to higher non-occupied space ratios) and a more difficult inspection of the inside of the vessels. Further, the use of partial wrapping (e.g. hoop-wrapped cylinders) for covering only the cylindrical part of the vessel, but not the ends of it, leads to an interface existing between the wrapped portion of the vessel and the end of the vessel where only the metal shell is exposed. That too can lead to problems, such as corrosion.

Also, transitions between materials in a continuous structural part usually constitute weaker areas, and hence the points in which failures are more likely to occur.

### Technical Problem to be Solved

The present invention therefore aims at overcoming or alleviating at least one of the disadvantages of the known pressure vessels.

In particular, an object of the present invention is to provide pressure vessels which are light in weight since a lighter vessel allows a greater volume of gas/fluid to be transported on a seafaring vehicle, such as a ship, without exceeding the vehicle's load bearing capacity—less of the carried weight (i.e. a smaller percentage) will be attributed to the physical vessels, as opposed to the contents of those vessels (i.e. the pressurized gas or the transported fluid).

### SUMMARY OF THE INVENTION

A first aspect of the present invention relates to a pressure vessel, in particular for compressed natural gas containment or transport, the pressure vessel (10) comprising:
at least one opening for gas loading and offloading and for liquid evacuation;
a non-metallic liner; and
at least one external fiber layer provided on the outside of the non-metallic liner.

The non-metallic liner may be substantially chemically inert.

The non-metallic liner may have a corrosion resistance of at least that of stainless steel, in relation to hydrocarbons or CNG, and impurities in such fluids, such as H₂S and CO₂.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state.

The non-metallic liner may be selected from the group comprising: high-density polyethylene, high-purity poly-dicyclopentadiene, resins based on poly-dicyclopentadiene, epoxy resins, polyvinyl chloride, or other polymers known to be impermeable to hydro-carbon gases, especially compressed natural gas polymers—the liner is desirably capable of hydraulic containment of raw gases, such as hydrocarbons and natural gas mixtures. The liner is also preferably inert to attack from such gases.

The fiber layer may be made of fiber wound about the non-metallic liner.

The fibers in the fiber layer may be selected from the group of carbon fibers, graphite fibers, E-glass fibers, or S-glass fibers.

The carbon fibers may be coated with a thermoset resin.

The thermoset resin may be selected from the group comprising epoxy-based or high-purity poly-dicyclopentadiene-based resins.

The vessel may further comprise a metallic internal coating provided on the inside of the non-metallic liner.

The metallic internal coating may be essentially H₂S resistant, for example in accordance with ISO15156.

The metallic internal coating should preferably not present sulfide stress-cracking at the 80% of its yield strength with a H₂S partial pressure of 100 kPa (15 psi), being the H₂ S partial pressure calculated (in megapascals—pounds per square inch) as follows:

$${p}_{{H}_{2} S} = p \times \frac{{x}_{{H}_{2} S}}{100}$$

where
ρ is the system total absolute pressure, expressed in megapascals (pounds per square inch;

x_{H}_{₂}_{S} is the mole fraction of H₂ S in the gas, expressed as a percentage.

The vessel may further comprise a gas permeable layer interposed between the non-metallic liner and the fiber layer.

The gas permeable layer may comprise glass fibers.

The vessel may further comprise a gas detector connected to the gas permeable layer for detecting a gas leakage.

The gas permeable layer may advantageously comprise an integrated gas detection device able to warn in case of leakage from the liner. The connection to such a device may by it being integrated into the wall of the vessel, e.g. in that layer. The device may be operated via a wireless transmission to a receiving unit elsewhere onboard the ship, usually nearby the pressure vessel.

The vessel may be of a generally cylindrical shape over a majority of its length. The fiber layer extends over all of the cylindrical shape, and over substantially all of the end portions of the vessel so as substantially entirely to cover the liner/vessel.

The inner diameter of the vessel may be between 0.5 meters and 5 meters.

The inner diameter may be between 1.5 meters and 3.5 meters.

The vessel may further comprise a manhole for entering and/or inspecting the interior of the vessel.

The present invention also provides a module or compartment comprising a plurality of the inspectable pressure vessels as defined above, the pressure vessels being interconnected for loading and offloading operations.

The present invention also provides a method of storing or transporting gas onshore or offshore, in particular compressed natural gas, using at least one pressure vessel, or the module or compartment, as defined above, the gas being contained within a pressure vessel thereof.

The present invention also provides a vehicle for transporting gas, in particular compressed natural gas, comprising at least one vessel, or a module or compartment, as defined above.

The vehicle may be a ship.

The vehicle may have multiple pressure vessels. They may all be interconnected, of they may be interconnected in groups or within their modules/compartments.

### Advantages of the Invention

The pressure vessel according to the present invention may allow to reduce the unit cost in production.

A further advantage of the present invention may be the reduced weight of the pressure vessel, especially compared to steel vessels.

Moreover, the present invention may allow less plastic material to be used for the pressure vessel, whilst maintaining its resistance to corrosion.

### BRIEF DESCRIPTION OF THE DRAWINGS

FIG. 1A is a schematic cross section of a manhole or opening section of a pressure vessel in accordance with the present invention'

FIG. 1B is a detailed schematic cross section of a manhole or opening section of a pressure vessel in accordance with the present invention;

FIG. 2 is a schematic cross section of a pressure vessel in accordance with the present invention;

FIGS. 3, 4 and 5 schematically illustrate an arrangement of a plurality of vessels in modules or compartments, in perspective, from the top side, the bottom side and from above, respectively;

FIGS. 6A, 6B and 6C schematically illustrate possible arrangements of the vessels in modules, and in the hull of a ship;

FIG. 7 schematically shows a section through a ship hull showing two modules arranged side by side; and

FIG. 8 schematically shows a more detailed view of the top-side pipework.

### DETAILED DESCRIPTION OF THE INVENTION

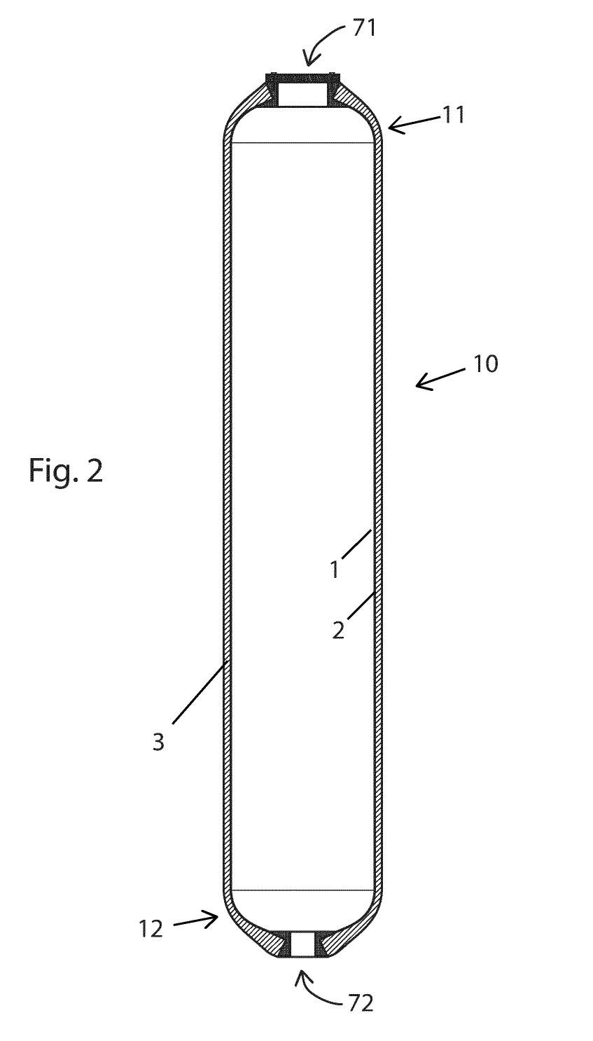

The present invention relates to a pressure vessel, in particular for compressed natural gas containment or transport. As shown in FIG. 2, the pressure vessel 10 in accordance with the present invention comprises at least one opening 71, 72 for gas loading and offloading and for liquid evacuation, a non-metallic liner 2, and at least one external fiber layer 3 provided on the outside of the non-metallic liner 2. With this arrangement, it is possible for the liner 2 to be wrapped or encased by an external composite layer 3.

The internal non-metallic liner 2 is capable of hydraulic containment of raw gases since a suitable thermoplastic or thermoset material is chosen for the liner such that it is non-permeable to the gas because of its micro-structural properties. Natural gas molecules cannot go through the liner because of both spacial arrangement and/or chemical affinity in these materials. Suitable materials for the liner include polymers such as high-density polyethylene (HDPE) and high-purity poly-dicyclopentadiene (DCPD). However, other materials capable of hydraulic containment of raw gases are known, and as such they might instead be used.

The internal liner 2 preferably has no structural purpose during CNG transportation, loading and offloading Phases.

The non-metallic liner 2 should be corrosion-proof and capable of carrying non-treated or unprocessed gases, i.e. raw CNG. When the non-metallic liner 2 is made from thermoplastic polymers it may be preferred to use a polyethylene or similar plastic which is capable of hydrocarbon corrosion resistance.

The manufacturing of such liners is preferably achieved through rotomolding. For example, a heated hollow mold is filled with a charge or shot weight of material. It is then slowly rotated (usually around two axes perpendicular with respect to each other) thus causing the softened material to disperse and to stick to the walls of the mold. In order to maintain an even thickness throughout the liner, the mold continues to rotate at all times during the heating phase, and to avoid sagging or deformation also during the cooling phase.

When the non-metallic liner 2 is made from thermoset resins it may be preferred to use a polyester, an epoxy, a resin based on poly-dicyclopentadiene or similar plastic capable of hydrocarbon corrosion resistance. The manufacturing of such liners may again be done through rotomolding. For example, a hollow mold is filled with an unhardened thermoset material, and it is then slowly rotated causing the unhardened material to disperse and stick to the walls of the mold.

It is to be appreciated that rotating in only one axis could be enough, especially for this latter embodiment due to the lower viscosity of thermoset compounds.

In order to maintain an even thickness throughout the liner, the mold will typically continue to rotate at all times during the hardening phase (through catalysts). This can also help to avoid sagging or deformation.

This construction also allows the tank to be able to carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

The non-metallic liner 2 can be provided such that it has only to carry the stresses due to manufacturing during the winding of fibers 3, while the structural support during pressurized transportation of gas will be carried out or provided by the external composite layer 3.

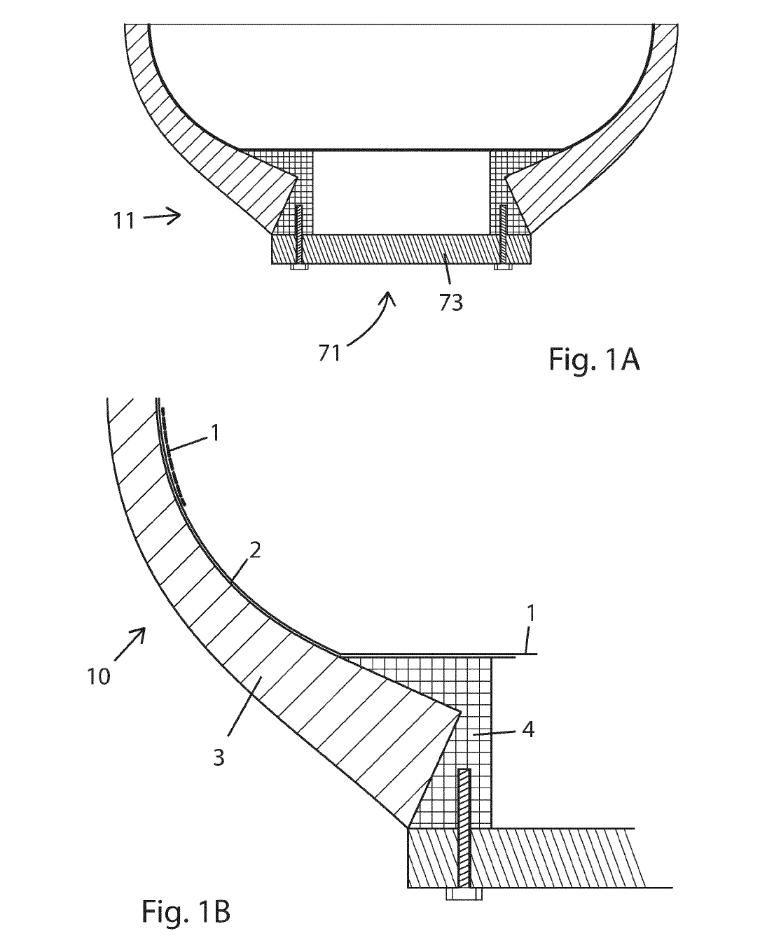

The internal surface of the non-metallic liner 2 may advantageously be coated by an internal coating 1 in order to enhance the permeability and corrosion resistance. See the optional dotted line in FIG. 1B, only shown on a part of the inner surface. It would in practice be located across the entire surface, but is only shown for illustrative purposes.

The internal coating 1 of the non-metallic liner 2 may be either a special thin layer of a resin with specific low permeability properties or a thin metallic layer. The deposition of the thin protective layer 1 in the case of metals may preferably involve a catalyst able to provide chemical bonding between the organic (polymeric) substrate and the selected low permeability metal or a solution comprising a salt of the preferred metal, a complexing agent and a reducing agent.

The external composite layer 3 will typically be a fiber-reinforced polymer (composite based on glass fibers, or carbon/graphite fibers, or aramid fibers), and it is provided as a reinforcement. It is formed so as to be substantially fully wrapping the vessel 10 (including the majority of the vessel's ends) and so as to be providing the structural contribution during service.

When glass fibers are used, it may be preferred, but not limited thereto, to use an E-glass or S-glass fiber, preferably with a suggested ultimate strength of 1,500 MPa or higher and/or a suggested Young Modulus of 70 GPa or higher. When using carbon fibers, is may be preferred, but not limited thereto, to use a carbon yarn, preferably with a strength of 3,200 MPa or higher and/or a Young Modulus of 230 GPa or higher. Preferably there are 12,000, 24,000 or 48,000 filaments per yarn.

The composite matrix may preferably be a polymeric resin thermoset or thermoplastic and more precisely, if thermoset, it may be an epoxy-based resin.

The pressure vessel 10 may further comprise a gas permeable layer interposed between the non-metallic liner 2 and the fiber layer 3. Advantageously, the gas permeable layer comprises glass fibers. The pressure vessel 10 may further comprise a gas detector connected to the gas permeable layer for detecting a gas leakage.

The outermost portion of the external composite layer 3 may further be impregnated using a resin with a high fire resistance, such as in accordance with NGV2-2007 or other internationally recognized standards and testing procedures in order to protect the vessel 10 from fire occurrence. This resin could be a thermoset such as a phenolic polymer.

With reference to FIG. 1, the opening 71 and/or 72 at at least one of the tank ends 11 and/or 12 may take the form of a nozzle that is also made out of composite materials, preferably in which the reinforcing fiber is carbon or graphite and the resin matrix is epoxy-based.

The manufacturing of the composite nozzle may involve the so-called closed-mold technique.

The manufacturing of the external composite layer 3 over the said non-metallic liner 2 preferably involves a winding technology. This can potentially give a high efficiency in terms of production hours. Moreover it can potentially provide good precision in the fibers' orientation. Further it can provide good quality reproducibility.

The reinforcing fibers preferably are wound with a back-tension over a mandrel. The mandrel is constituted by the non-metallic liner 2. The non-metallic liner 2 thus constitutes the male mould for this technology. The winding is advantageously performed after the fibers have been pre-impregnated in the resin. Impregnated fibers are thus preferably deposited in layers over said non-metallic liner 2 until the desired thickness is reached for the given diameter. For example, for a diameter of 6m, the desired thickness might be about 350 mm for carbon-based composites or about 650 mm for glass-based composites.

Since this invention relates to a substantially fully-wrapped pressure vessel 10, it may be preferable to use a multi-axis crosshead for fibers in the manufacturing process.

The process preferably also includes a covering of the majority of the ends (11, 12) of the pressure vessel 10 with the structural external composite layer 3.

When using thermoset resins an impregnating basket may be used for impregnating the fibers before actually winding the fibers around the non-metallic liner 2.

When using thermoplastic resins, there can be a heating of the resin before the fiber deposition in order to melt the resin just before reaching the mandrel, or the fibers may be impregnated with thermoplastic resin before they are deposited as a composite material on the metal liner. The resin is again heated before depositing the fibers in order to melt the resin just before the fiber and resin composite reaches the non-metallic liner 2.

The pressure vessel 10 may preferably be provided with at least one opening 71 and/or 72 intended for gas loading and offloading and liquid evacuation. The opening 71 and/or 72 may be placed at either end 11, 12 of vessel 10, but as shown in FIG. 2 it is preferred to provide an opening 72 at the bottom end 12. It may advantageously be a 12-inch (30 cm) opening for connecting to pipework.

The pressure vessel 10 also has an opening 71 at the top end 11 and it is advantageously in the form of an at least 18-inch (45 cm) wide access manhole 6, such as one with a sealed or sealable cover (or more preferably a 24-inch (60 cm) manhole). It is preferably provided according to ASME (American Society of Mechanical Engineers) standards. Preferably the opening 71 is provided with closing means 73 (see FIG. 1A), which allows a sealed closing of the opening during gas transportation, such as by bolting it down, but which allows internal inspection when the vessel 10 is not in use, such as by a person removing the closing means and climbing into the vessel through the opening/manhole 6.

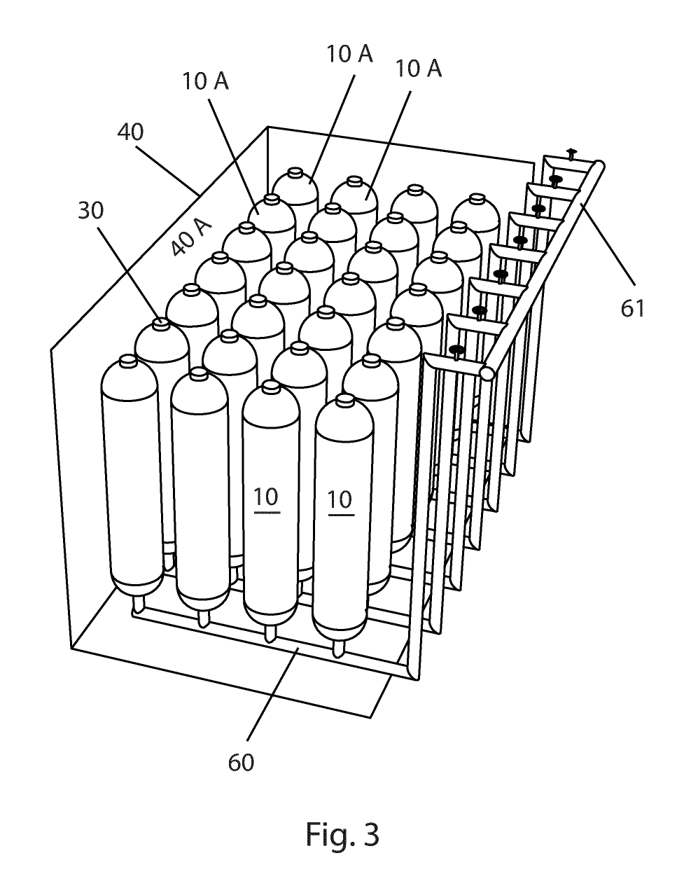

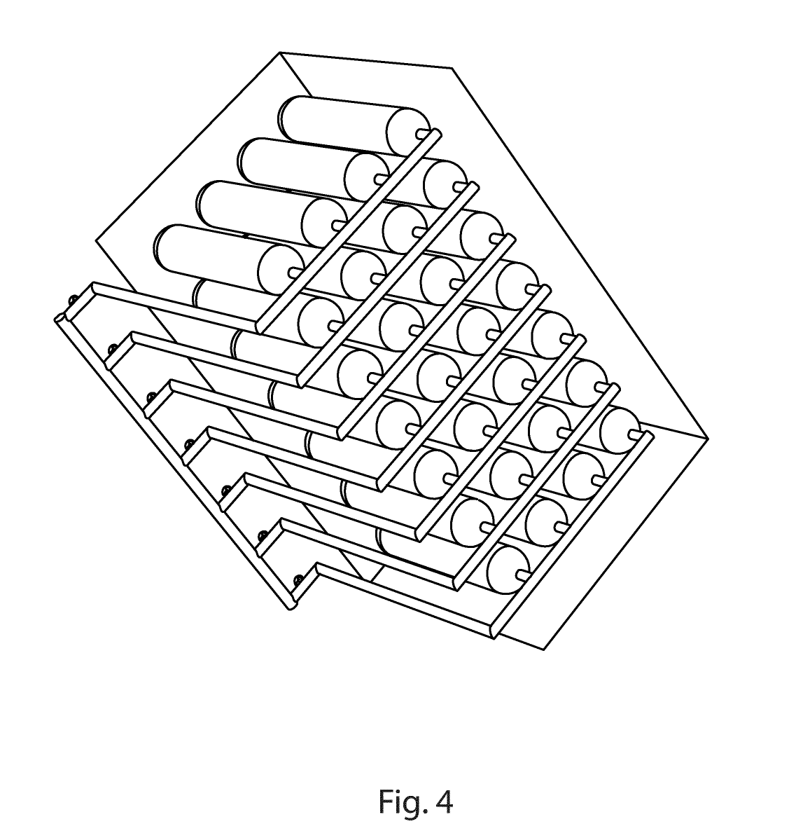

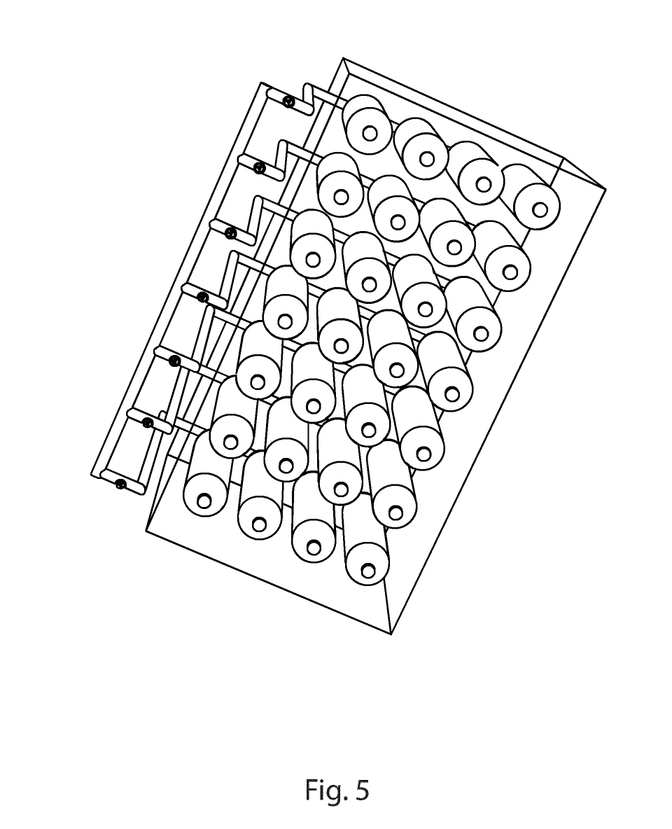

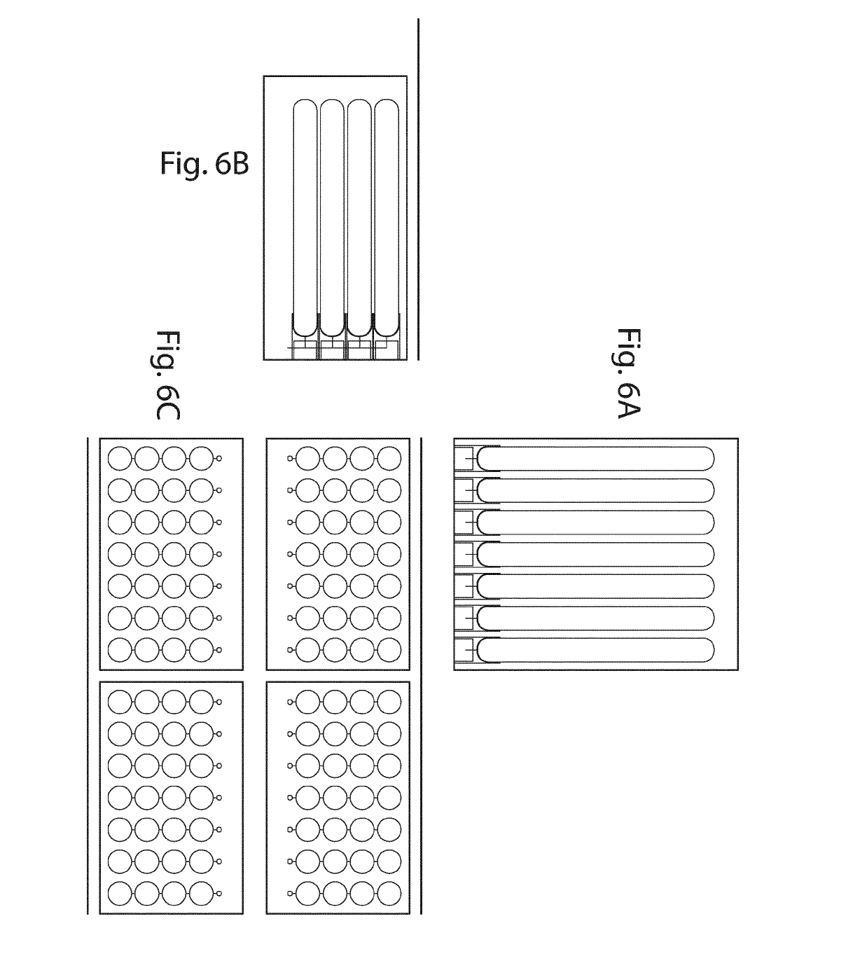

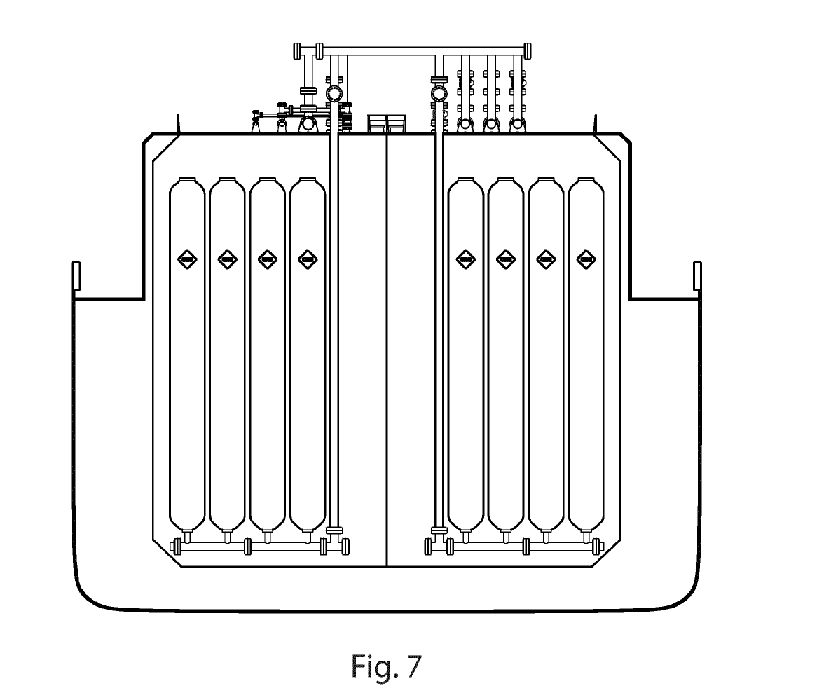

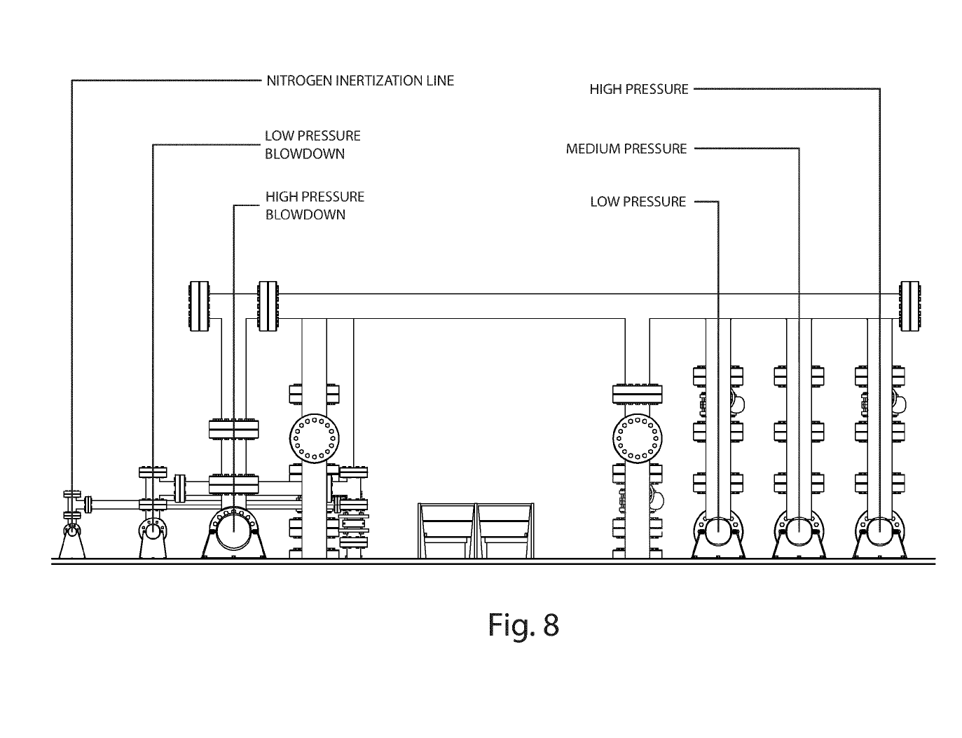

FIG. 3 illustrates an advantageous arrangement of a plurality of vessels in modules or compartments 40. The pressure vessels 10 can be arranged in a ship's hull (see FIG. 7) in modules or compartments 40 and the vessels 10 can be interconnected for loading and offloading operations, such as via pipework 61. In a preferred configuration, such modules or compartments 40 have four edges (are quadrilateral-shaped) and contain a plurality of vessels 10. The number of vessels chosen will depend upon the vessel diameter or shape and the size of the modules or compartments 40. Further, the number of modules or compartments will depend upon the structural constraints of the ship hull for accommodating the modules or compartments 40. It is not essential for all the modules or compartments to be of the same size or shape, and likewise they need not contain the same size or shape of pressure vessel, or the same numbers thereof.

The vessels 10 may be in a regular array within the modules or compartments—in the illustrated embodiment a 4×7 array. Other array sizes are also to be anticipated, whether in the same module (i.e. with differently sized pressure vessels), or in differently sized modules, and the arrangements can be chosen or designed to fit appropriately in the ship's hull.

For external inspection-ability reasons it is preferred that the distance between the vessels 10 within the modules or compartments 40 be at least 380 mm, or more preferably at least 600 mm. These distances also allow space for vessel expansion when loaded with the pressurised gas—the vessels may expand by 2% or more in volume when loaded (and changes in the ambient temperature can also cause the vessel to change their volume).

Preferably the distance between the modules or compartments 40 or between the outer vessels 10A and the walls or boundaries 40A of the modules or compartments 40, or between adjacent outer vessels of neighbouring modules or compartments 40 (such as where no physical wall separates neighbouring modules or compartments 40) will be at least 600 mm, or more preferably at least 1 m, again for external inspectionability reasons, and/or to allow for vessel expansion.

Still with reference to FIG. 3, each pressure vessel row (or column) is interconnected with a piping system 60 intended for loading and offloading operations from the bottom 12 of each vessel 10, such as through the preferably 12 inch (30cm) opening 72 to main headers, such as through motorized valves.

The main headers can comprise various different pressure levels, for example three of them (high—e.g. 250 bar, medium—e.g. 150 bar and low—e.g. 90 bar), plus one blow down header and one nitrogen header for inert purposes.

Also as shown in FIG. 3, the vessels 10 are preferred to be mounted vertically, preferably on dedicated supports or brackets, or by being strapped into place. The supports (not shown) hold the vessels 10 in order to avoid horizontal displacement of the vessels relative to one another. Clamps, brackets or other conventional pressure vessel retention systems, may be used for this purpose, such as hoops or straps that secure the main cylinder of each vessel.

The supports can be designed to accommodate vessel expansion, such as by having some resilience.

When the vessels 10 are vertically mounted, they are less critical in following dynamic loads resulting from the ship motion. Moreover the vertical arrangement allows an easier replacement of single vessels in the module or compartment 40 when necessary—they can be lifted out without the need to first remove other vessels from above. This configuration can also potentially allow a fast installation time. Mounting the vessels 10 in vertical positions also allows condensed liquids to fall under the influence of gravity to the bottom, thereby being off-loadable from the vessels using, e.g. the 12 inch opening 7 at the bottom of each vessel 10.

Offloading of the gas will advantageously also be from the bottom of the vessel 10.

With the majority of the piping and valving 60 installed towards the bottom of the modules 40, the center of gravity of the whole arrangement will be also in a low position, which is recommended or preferred, especially for improving stability at sea, or during gas transportation.

Modules or compartments 40 are preferably kept in a controlled environment with nitrogen gas occupying the space between the vessels 10 and the modules' walls 40A, thus reducing fire hazard. Alternatively, the engine exhaust gas could be used for this inerting function thanks to its composition being rich in CO₂.

By maximizing the size of the individual vessels 10, such as by making them, for example, up to 6 meter in diameter and up to 30 meters in length, for the same total volume contained the total number of vessels 10 may be reduced, which in turn allows to reduce connection and inter-piping complexity, and hence reduces the number of possible leakage points, which usually occur in weaker locations such as weldings, joints and manifolds. Preferred arrangements call for diameters of at least 2m.

One dedicated module may be set aside for liquid storage (such as condensate) using the same concept of interconnection used for the gas storage. The modules 40 are thus potentially all connected together to allow a distribution of such liquid from other modules 40 to the dedicated module—a ship will typically feature multiple modules 40.

In and out gas storage piping may advantageously be linked with at least one of metering, heating, and/or blow down systems and scavenging systems through valve-connected manifolds. They may preferably be remotely activated by a Distributed Control System (DCS).

Piping diameters are preferably as follows:
18 inch. for the three main headers (low, medium and high pressure) dedicated to CNG loading/offloading.
24 inch. for the blow-down CNG line.
6 inch. for the pipe feeding the module with the inert gas.
10 inch. for the blow-down inert gas line.
10 inch. for the pipe dedicated to possible liquid loading/offloading.

All modules may preferably be equipped with adequate firefighting systems, as foreseen by international codes, standards and rules.

The transported CNG will typically be at a pressure in excess of 60 bar, and potentially in excess of 100 bar, 150 bar, 200 bar or 250 bar, and potentially peaking at 300 bar or 350 bar.

### Embodiments

### EXAMPLE 1

A thermoplastic liner 2 such as high-density polyethylene—HDPE with a density between 0.9 and 1.1 g/cm³, a tensile strength of at least 30 MPa over-wrapped with a composite structure 3 based on carbon or graphite fiber reinforcement preferably using a carbon yarn with a strength of 3,200 MPa or higher and a Young Modulus of 230 GPa or higher, with 12,000, 24,000 or 48,000 filaments per yarn and a thermoset resin (epoxy-based or high-purity poly-dicyclopentadiene-based resins). The thermoplastic liner 2 is produced by multi-axis rotomolding as explained in the description of the invention.

### EXAMPLE 2

A thermoset liner 2 such as high-purity poly-cyclopentadiene—pDCPD with a density between 0.9 and 1.1 g/cm³, a tensile strength of at least 65 MPa over-wrapped with a composite structure 3 based on carbon or graphite fiber reinforcement using a carbon yarn with a strength of 3,200 MPa or higher and a Young Modulus of 230 GPa or higher, with 12,000, 24,000 or 48,000 filaments per yarn and a thermoset resin (epoxy-based or high-purity poly-dicyclopentadiene-based resins). The thermoset liner 2 is produced by a single-axis rotomolding machine as explained in the description of the invention.

### EXAMPLE 3

A thermoset liner 2 such as high-purity poly-cyclopentadiene—pDCPD with a density between 0.9 and 1.1 g/cm³, a tensile strength of at least 65 MPa over-wrapped with a composite structure 3 based on carbon or graphite fiber reinforcement using a carbon yarn with a strength of 3,200 MPa or higher and a Young Modulus of 230 GPa or higher, with 12,000, 24,000 or 48,000 filaments per yarn and a thermoset resin (epoxy-based or high-purity poly-dicyclopentadiene-based resins) and a metallic internal coating 1 of the liner capable of H₂S resistance in accordance with the International Standard (ISO) 15156. The thermoset liner is produced by a single-axis rotomolding machine to be produced as explained in the description of the invention.

### EXAMPLE 4

A thermoplastic liner 2 such as high-density polyethylene (HDPE) with a density between 0.9 and 1.1 g/cm³ and a tensile strength of at least 30 MPa is over-wrapped with a composite structure 3 based on an E-glass or S-glass fiber with an suggested ultimate strength of 1,500 MPa or higher and a suggested Young Modulus of 70 GPa or higher and thermoset resin (epoxy-based or high-purity high-purity poly-dicyclopentadiene-based resins). The thermoplastic liner 2 is produced by multi-axis rotomolding as explained in the description of the invention.

### EXAMPLE 5

A thermoset liner 2 such as high-purity poly-cyclopentadiene—pDCPD with a density between 0.9 and 1.1 g/cm³, a tensile strength of at least 65 MPa over-wrapped with a composite structure 3 based on an E-glass or S-glass fiber with an suggested ultimate strength of 1,500 MPa or higher and a suggested Young Modulus of 70 GPa or higher and thermoset resin (epoxy-based or high-purity poly-dicyclopentadiene-based resins).

The thermoset liner 2 is produced by a single-axis rotomolding machine as explained in the description of the invention.

### EXAMPLE 6

A thermoset liner 2 such as high-purity poly-cyclopentadiene—pDCPD with a density between 0.9 and 1.1 g/cm³, a tensile strength of at least 65 MPa over-wrapped with a composite structure 3 based on an E-glass or S-glass fiber with an suggested ultimate strength of 1,500 MPa or higher and a suggested Young Modulus of 70 GPa or higher and thermoset resin (epoxy-based or high-purity poly-dicyclopentadiene-based resins) and a metallic internal coating 1 of the liner 2 capable of H₂ S resistance in accordance with the International Standard (ISO) 15156. The thermoset liner 2 is produced by a single-axis rotomolding machine as explained in the description of the invention.

No doubt many other effective alternatives will occur to the skilled person. It will be understood that the invention is not limited to the described embodiments and encompasses modifications apparent to those skilled in the art lying within the spirit and scope of the claims appended hereto.

1. A pressure vessel, in particular for compressed natural gas containment or transport, the pressure vessel comprising:
at least one opening for gas loading and offloading and for liquid evacuation;
a non-metallic liner; and
at least one external fiber layer provided on the outside of the non-metallic liner.

2. The pressure vessel according to claim 1, wherein the non-metallic liner is substantially chemically inert.

3. The pressure vessel according to claim 2, wherein the non-metallic liner has a corrosion resistance of at least that of stainless steel.

4. The pressure vessel according to claim 1, wherein the non-metallic liner is selected from the group comprising: high-density polyethylene, high-purity poly-cyclopentadiene, epoxy resins, polyvinyl chloride.

5. The pressure vessel according to claim 1, wherein the fiber layer is made of fiber wound about the non-metallic liner.

6. The pressure vessel according to claim 1, wherein the fibers in the fiber layer are selected from the group of carbon fibers, graphite fibers, E-glass fibers, or S-glass fibers.

7. The pressure vessel according to claim 6, wherein the carbon fibers are coated with a thermoset resin.

8. The pressure vessel according to claim 7, wherein the thermoset resin is selected from the group comprising epoxy-based or high-purity poly-dicyclopentadiene-based resins.

9. The pressure vessel according to claim 1, further comprising a metallic internal coating provided on the inside of the non-metallic liner.

10. The pressure vessel according to claim 9, wherein the metallic internal coating is essentially H₂S resistant.

11. The pressure vessel according to claim 1, further comprising a gas permeable layer interposed between the non-metallic liner and the fiber layer.

12. The pressure vessel according to claim 11, wherein the gas permeable layer comprises glass fibers.

13. The pressure vessel according to claim 11, further comprising a gas detector connected to the gas permeable layer for detecting a gas leakage.

14. The pressure vessel according to claim 1, wherein the pressure vessel is of a generally cylindrical shape over a majority of its length.

15. The pressure vessel according to claim 1, wherein the inner diameter of the vessel is between 0.5 meters and 5 meters, more particularly between 1.5 meters and 3.5 meters.

16. (canceled)

17. The pressure vessel according to claim 1 further comprising a manhole for entering and/or inspecting the interior of the vessel.

18. A module or compartment comprising a plurality of the inspectable pressure vessels as defined in claim 1, the pressure vessels being interconnected for loading and offloading operations.

19. A method of storing or transporting gas onshore or offshore, in particular compressed natural gas, using at least one pressure vessel according to claim 1.

20. A vehicle, in particular a ship, for transporting gas, in particular compressed natural gas, comprising at least one vessel according to claim 1.

21. (canceled)

22. The vehicle according to claim 19, wherein there are multiple pressure vessels and they are interconnected.
